(19) United States
(12) Patent Application Publication
(10) Pub. No.: US 2012/0297974 A1
(43) Pub. Date: Nov. 29, 2012

(54) SYSTEM FOR COLLECTING POLLUTED AIR, DEVICE FOR COLLECTING POLLUTED AIR AND METHOD THEREOF

(75) Inventor: Sung-il Hwang, Seoul (KR)

(73) Assignee: MAXFOR TECHNOLOGY INC., Seongnam-si, Gyeonggi-do (KR)

(21) Appl. No.: 13/575,603

(22) PCT Filed: Jan. 27, 2010
(86) PCT No.: PCT/KR2010/000493

§ 371 Date: Jul. 26, 2012

(51) Int. Cl. B01D 53/30; B01D 46/46

(52) U.S. Cl. 95/1; 96/413

(57) ABSTRACT

An apparatus for collecting contaminated air, including: an air pollution detecting unit for monitoring pollution status of air existing in the pertinent area; an air collecting unit for collecting and storing part of the air; and a control unit for comparing data about the pollution status monitored by the detecting unit with preset critical values and commanding the collecting unit to collect a part of the air when data about the pollution status is equal to or greater than the critical values. Since contaminated air is collected by monitoring the pollution status of contaminated air existing in the atmosphere of a pertinent area or the gaseous contaminant-containing air discharged from sources in real time, it is possible to collect air pollution evidence. The collecting unit provided at the outlet of a source, allows air pollution data to be stored after analyzing collected air, making it possible to lawfully sanction air polluter.

### TECHNICAL FIELD

The present invention relates to a system for collecting contaminated air, an apparatus for collecting contaminated air, and a method of collecting contaminated air.

### BACKGROUND ART

Generally, environmental pollution is the phenomena of contaminants, such as sooty smoke, dust, bad smells, noise, vibrations, sewage, waste, radioactive materials and the like, being discharged by the operations of human livings or production and consumption so that living conditions are polluted. It has a harmful influence on the health, existence and activity of humans or living things. Air pollution, water pollution, soil pollution, noise, vibrations, ground subsidence, bad smells and the like, which are caused by various human activities, such as production activities conducted in factories, business places and the like, transportation activities using automobiles, trains, airplanes, ships and the like, and daily activities including cooling and warming, cooking, leisure and the like, destroy the natural environment or the living environment, thus exerting a bad influence on the life and health of human beings.

Among such types of environmental pollution, air pollution is a state in which contaminants discharged from artificial pollution sources exist in the atmosphere in large quantities to such a degree that they directly harm living things or property. In the case of air pollution, since there is an excess of artificially or naturally discharged contaminants in the atmosphere, the components of the atmosphere change, and the quality thereof deteriorates, thus exerting a bad influence on the life activities of humans, plants and animals.

Further, air pollution is the phenomenon of air being polluted by gases and the like discharged from automobiles, chimneys of factories or high-rise buildings, and the like. Air pollution is a typical environmental pollution in modern cities. As such, if humans inhale seriously-contaminated air, this can result in respiratory diseases, such as pulmonary cancer and the like, humans' heads become very painful and dizzy, and the human throat becomes clogged, thus doing harm to humans. For example, humans living in the center of a large city or in an industrial zone are subjected to headaches or dizziness in the afternoon because of air pollution, and smog, which is caused by a combination of smoke and fog, frequently occurs in a large city or an industrial zone. When smog becomes serious, humans cannot see scenes, and thus smog becomes the main cause of traffic accidents.

Thus, conventionally, a system for observing contaminated air in the pertinent area by monitoring the state of the discharged air contaminants in real time using a sensor network has been used. However, this system is problematic in that it only confirms that the air is contaminated and cannot easily be used to collect evidence that the air is contaminated, so that it is difficult to impose a fine on air pollution sources or apply sanctions against air pollution sources and to record field evidence.

In other words, with conventional technologies, it is difficult to inflict punishment for the discharge of air contaminants. Therefore, it is required to develop technology that can solve this problem.

### DISCLOSURE

### Technical Problem

Accordingly, the present invention has been devised to solve the above-mentioned problems, and an object of the present invention is to provide a technology for providing grounds that can apply sanctions against air pollution sources by monitoring the contaminated air in the pertinent area using sensor nodes.

### Technical Solution

In order to accomplish the above object, an aspect of the present invention provides an apparatus for collecting contaminated air, including: an air pollution detecting unit for monitoring pollution status of air existing in a pertinent area; an air collecting unit for collecting and storing some of the air; and a control unit for comparing data about the air pollution status monitored by the air pollution detecting unit with preset critical values and commanding the air collecting unit to collect some of the air when the data about the air pollution status is equal to or greater than the critical values.

The apparatus may further include a communication unit for transmitting the data about the air pollution status monitored by the air pollution detecting unit to the outside.

The apparatus may further include a data storage unit for storing the data about the air pollution status monitored by the air pollution detecting unit.

The apparatus may further include an external interface unit connected to external terminals such that critical values for comparing the data about the air pollution status are set.

In the apparatus, the air may be air containing gaseous contaminants discharged from an outlet.

Another aspect of the present invention provides a system for collecting contaminated air, including: an air pollution detecting unit for monitoring pollution status of air existing in the pertinent area; an air collecting unit for collecting and storing some of the air; a control unit for comparing data about the air pollution status monitored by the air pollution detecting unit with first preset critical values and commanding the air collecting unit to collect some of the air when the data about the air pollution status is equal to or greater than the first preset critical values; and a communication unit for transmitting the data about the air pollution status monitored by the air pollution detecting unit to the outside.

The system may further include a management apparatus for receiving the information monitored by the air pollution detecting unit and comparing data about the air pollution status with second preset critical values and commanding the air collecting unit to collect some of the air when the data about the air pollution status is equal to or greater than the second preset critical values, wherein the air collecting unit collects and stores some of the air depending on the comparison in the management apparatus.

In the system, the management apparatus may further include: a data storage unit for storing the data about the air pollution status; a communication unit for transmitting and receiving the data about the air pollution status to and from the air collection unit; and a control unit for comparing the data about the air pollution status with first preset critical values and commanding the air collecting unit to collect some of the air.

The system may further include a management interface unit connected to external terminals such that critical values for comparing the data about the air pollution status can be set.

In the system, the air may be air containing gaseous contaminants discharged from an outlet.

Still another aspect of the present invention provides a method of collecting contaminated air, including the steps of: receiving data about air pollution status in a pertinent area from the outside; comparing the received data about the air pollution status with preset critical values; and commanding an air collecting unit to collect some of the air when the data about the air pollution status is equal to or greater than the preset critical values.

The method may further include the step of storing the received data in a database.

Still another aspect of the present invention provides a method of collecting contaminated air, including the steps of: monitoring air pollution status in a pertinent area; comparing the data about the monitored air pollution status with preset critical values; and collecting some of the air when the data about the air pollution status is equal to or greater than the preset critical values.

The method may further include the step of transmitting the data about the monitored air pollution status to the outside.

The method may further include the step of storing the data about the monitored air pollution status in a database.

In the method the air may be air containing gaseous contaminants discharged from an outlet.

### Advantageous Effects

As described above, according to the present invention, since contaminated air is collected by monitoring the pollution status of the contaminated air existing in the atmosphere of the pertinent area or the gaseous contaminant-containing air discharged from factories and the like in real time, it is possible to collect evidence of air pollution.

Further, according to the present invention, since air including gaseous contaminants is collected by an air collecting unit provided at the outlet of a factory or the like, data for air pollution can be stored by analyzing the collected air, so that it is possible to apply lawful sanctions against air pollution sources, thereby preventing environmental pollution.

### DESCRIPTION OF DRAWINGS

FIG. 1 is a block diagram showing an apparatus for collecting contaminated air according to an embodiment of the present invention;

FIG. 2 is a block diagram showing a system for collecting contaminated air according to an embodiment of the present invention;

FIG. 3 is a block diagram showing a management apparatus of FIG. 2; and

FIGS. 4 and 5 are flowcharts showing methods of collecting contaminated air according to other embodiments of the present invention.

### DESCRIPTION OF THE REFERENCE NUMERALS IN THE DRAWINGS

100: apparatus for collecting contaminated air

110: control unit

120: air pollution detecting unit

130: air collecting unit

140: power unit

150: communication unit

160: data storage unit

170: external interface unit

200: system for collecting contaminated air

210: collected information providing apparatus

220: management apparatus

221: storage unit

222: control unit

223: communication unit

224: management interface unit

### BEST MODE

Hereinafter, preferred embodiments of the present invention will be described in detail with reference to the accompanying drawings. Here, a description of well known technical parts will be omitted or shortened for the sake of brief explanation.

### First Embodiment: Configuration

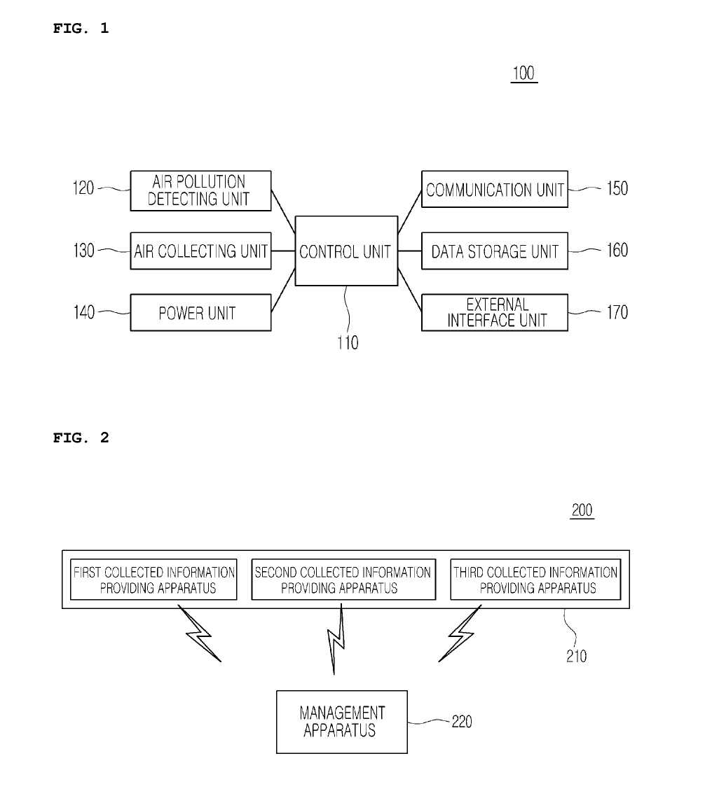

As shown in FIG. 1, the apparatus 100 for collecting contaminated air according to a first embodiment of the present invention includes a control unit 110, an air pollution detecting unit 120, an air collecting unit 130, a power unit 140, a communication unit 150, a data storage unit 160, and an external interface unit 170.

The control unit 110 is configured such that, when the data about the air pollution status monitored in real time by the air pollution detecting unit 120 is higher than the critical values established by users, the control unit 110 commands the air collecting unit 130 to collect and store some of the air.

Further, the control unit 110 may be configured to convert the information about contaminated air into data and compare the data with predetermined critical values.

The air pollution detecting unit 120 monitors the pollution status of air in real time, and monitors the air in the pertinent area in real time to provide information about air pollution.

The air collecting unit 130 is configured to collect and store some air. When the air collecting unit 130 receives the command to collect air from the control unit 110, the air collecting unit 130 collects some of the air containing contaminants, and then stores the collected contaminated air.

The power unit 140 serves to supply the power necessary to drive the contaminated air collecting apparatus 100. The apparatus 100 for collecting contaminated air may be configured such that it can be operated by an ON/OFF switch provided at the outside thereof.

The communication unit 150 serves to transmit the data about air pollution to the outside. Specifically, the communication unit 150 serves to transmit the data about the pollution status of the air monitored by the air pollution detecting unit 120 to the outside.

Further, the communication unit 150 transmits the data monitored and collected by the air pollution detecting unit 120 to the outside such that the data can be externally managed. For this purpose, the data is transmitted from the communication unit 150 to a management apparatus 220 through a gateway, and the management apparatus 220 manages the data.

The data storage unit 160 stores the data monitored by the air pollution detecting unit 120, and the data can be classified by date and time.

The external interface unit 170 is connected to external units such that critical values can be set in order to compare the data about air pollution.

### Second Embodiment: Configuration

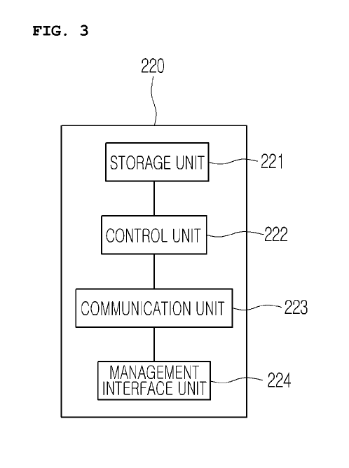

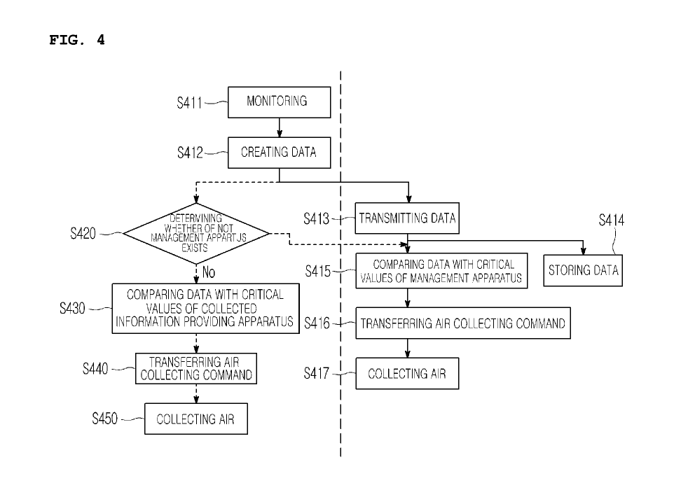

As shown in FIGS. 2 and 3, the system 100 for collecting contaminated air according to a second embodiment of the present invention includes a collected information providing apparatus 210 and a management apparatus 220.

The configuration of the collected information providing apparatus 210 is similar to that of the contaminated air collecting apparatus 100 according to the first embodiment of the present invention. Therefore, a description thereof that overlaps with that of the contaminated air collecting apparatus 100 will be omitted. The collected information providing apparatus 210 is an apparatus for monitoring the contaminated air existing in the atmosphere of the pertinent area or the gaseous contaminant-containing air discharged from factories and the like in the pertinent area and collecting a part of the air depending on the pollution status thereof, and includes the air pollution detecting unit 120 and the air collecting unit 130.

Here, the collected information providing apparatus 210 is a kind of sensor node, functions to measure the pollution status of the air in the pertinent area to monitor the information about the pollution status thereof, and functions to transmit the monitored information to the outside. That is, the collected information providing apparatus 210 is configured such that the pollution status of the contaminated air existing in the atmosphere of the pertinent area or the gaseous contaminant-containing air discharged from the factories and the like is monitored in real time, the monitored pollution status of the air is formed into data, and the data is transmitted to the management apparatus 220 in real time.

Hereinafter, the configuration of the sensor node will be described as the above description of the first embodiment.

Meanwhile, sensor nodes are arranged at regular distances in a predetermined geographical area such as an industrial complex or the like to construct a ubiquitous sensor network (USN). Owing to the construction of the ubiquitous sensor network (USN), a specific area can be managed as a whole.

Here, the ubiquitous sensor network (USN) refers to an advanced intellectual social infrastructure, which detects, stores, processes and integrates environmental information about things using tags and sensor nodes attached anywhere, and which can freely use ordered services by creating circumstantial recognition information and knowledge contents.

The air pollution detecting unit 120 is configured to monitor the pollution status of air existing in the pertinent area in real time.

Further, the data about the air pollution status monitored by the air pollution detecting unit 120 is compared with the critical values preset in the collected information providing apparatus 210, and the compared data about the air pollution status and the information about the command of air collection are transmitted to the management apparatus 220.

Therefore, the management apparatus 220 manages the data about the air pollution status and the information about the command to collect air, which are transmitted from the collected information providing apparatus 210, and selectively determines whether the data about the air pollution status is to be compared with the critical values preset in the management apparatus 220 or those which have been preset in the collected information providing apparatus 210.

The air collecting unit 130 is configured to collect contaminated air in response to the air collection command transmitted from the management apparatus 220. That is, the air collecting unit 130 receives the air collection command transmitted from the management apparatus 220 to the collected information providing apparatus 210 and then collects some of the contaminated air in response to the air collection command.

Here, as an example of the collection of contaminated air, the collected information providing apparatus 210 for collecting contaminated air existing in the atmosphere is provided in the area subject to being managed, and allows the air pollution detecting unit 120 to monitor the air pollution status in real time.

Thus, when the data about the air pollution status monitored by the air pollution detecting unit 120 is higher than the critical values set by users, the control unit 110 commands the air collecting unit 130 to collect contaminated air using a pump or the like, and the contaminated air collected in this way is stored in an air storage tank of the air collecting unit 130.

In this case, when the pressure in the air storage tank is increased to a certain pressure because of the collected air, the air collecting unit 130 determines that the collection of air has completed, and the control unit 130 commands the air collecting unit 130 to stop collecting air and informs the outside of the completion of air collection, thus enabling the air storage tank of the air collecting unit 130 to be replaced.

Here, the air storage tank for storing some air may be made of vinyl or the like. The air having a pollution status above the critical values is marked with the date and time when being collected later by a collector. The air collected in this way is analyzed by a detailed item test, and the data analyzed in this way can be used later as evidence.

The management apparatus 220 receives data from the collected information providing apparatus 210, compares the data about air pollution status with predetermined critical values, and sends the command to collect some contaminated air to the collected information providing apparatus 210 when the values of the compared data are equal to or greater than critical values. The management apparatus 220 includes a storage unit 221, a control unit 222, a communication unit 223 and a management interface unit 224.

The storage unit 221 serves to store transmitted data, and may be configured to store the information about air pollution and use the stored information if necessary.

The control unit 222 serves to compare the transmitted data with the critical values set by users and to allow the air collecting unit to collect some air.

The communication unit 223 serves to transfer the air collection command to the collected information providing apparatus 210 to which data was transmitted.

The management interface unit 224 is configured to be connected with external units such that the critical values for comparing the data about the air pollution status can be set.

Further, the data transmitted from the communication unit 223 of the management apparatus 220 can be transmitted to the collected information providing apparatus 210 through a gateway.

Here, the gateway is used to connect a LAN or wireless LAN to the Internet or a wide area network, and is configured to serve as a repeater for transmitting the data transmitted from at least one collected information providing apparatus 210 to the management apparatus 220 or transmitting the data transmitted from the management apparatus 220 to at least one collected information providing apparatus 210. Of course, if necessary, data communication can be directly established between the collected information providing apparatus 210 and the management apparatus 220.

Meanwhile, in the first embodiment and the second embodiment, air pollutants existing in the atmosphere include particulate contaminants (dust) and gaseous contaminants.

Particulate contaminants are very small liquid or solid floating substances. When particulate contaminants are referred to as particles, they include only solid floating substance. However, when they are referred to as aerogel, they include both liquid floating substances and solid floating substances.

Gaseous contaminants are gas-phase air pollutants generated from industrial activities and human activities, and include carbon-containing gases, sulfur oxides (SOₓ), nitrogen oxides (NOₓ), ozone (O₃) and the like.

Here, carbon-containing gases include carbon monoxide (CO), hydrocarbons, hydrocarbon oxides, and the like. Carbon monoxide is produced by the incomplete combustion of fossil fuel, and is a colorless and odorless noxious gas.

Further, when sulfur-containing fuel is combusted, sulfur is bonded with oxygen in the air to be formed into sulfur dioxide (SO₂). This sulfur dioxide (SO₂) is a gas which is very toxic in high concentrations.

Further, nitrogen-containing gases include nitrogen monoxide (NO), nitrogen dioxide (NO₂), nitrous oxide (N₂O), nitrogen anhydride (N₂O₃) and the like. Particularly, NO and NO₂ are referred to as NOₓ.

Finally, ozone is a substance consisting of three oxygen atoms. Ozone is naturally generated, and is produced by the chemical reaction of a nitrogen oxide with a hydrocarbon with the help of solar light near the earth's surface.

Therefore, the contaminated air collecting apparatus of the present invention can be configured such that air pollutant sources are punished by collecting a part of air including particulate contaminants or gaseous contaminants.

### First Embodiment: Method

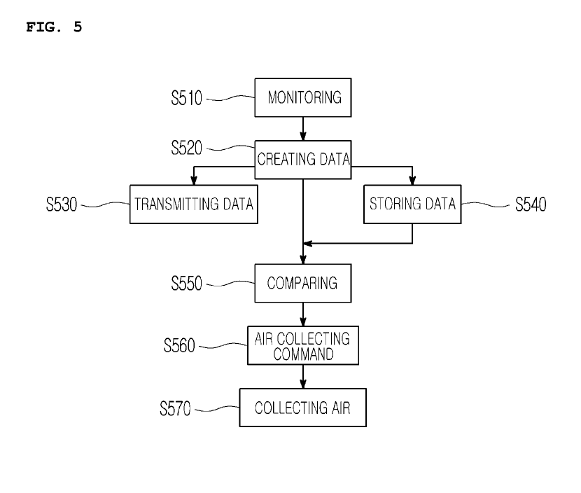

The method of collecting contaminated air according to a first embodiment of the present invention will be described in detail through a flowchart shown in FIG. 4 with reference to FIGS. 1 to 3.

1. Monitoring (S411)

The contaminated air existing in the atmosphere of the pertinent area or the gaseous contaminant-containing air discharged from factories and the like is detected and monitored in real time. That is, air pollution status is monitored in real time.

2. Creating Data (S412)

The information about the air pollution status monitored in S411 is changed into data. The data can be compared in the following step.

3. Transmitting Data (S413)

The data created in S412 is transmitted to the management apparatus 220. Here, the data can be transmitted through a gateway connected a wide area network, and the data can also be directly transmitted from the collected information providing apparatus 210 to the management apparatus 220. Here, the gateway may be configured to serve as a repeater for receiving weak signals and then sending strong signals corresponding to the weak signals.

4. Storing Data (S414)

The data transmitted in S413 is stored in the storage unit 221 of the management apparatus. Here, since the transmitted data is stored in a database and then stored in the storage unit 221, the stored data can be used when needed.

5. Comparing Data with Critical Values of Management Apparatus (S415)

The data transmitted in S413 is compared with the critical values preset by users. That is, the data about air pollution status is compared with the preset critical values.

6. Transferring Air Collecting Command (S416)

When the air pollution status data compared in S415 is higher than the critical values preset by users, the air collection command to collect some air existing in the pertinent area is transferred to the pertinent area.

7. Collecting Air (S417)

The air collecting unit 130 receives the air collection command transferred in S416 to collect and store a part of the contaminated air.

<Method of Collecting Contaminated Air According to Whether or not a Management Apparatus Exists>

Method of collecting contaminated air according to whether or not a management apparatus exists may be realized as follows.

1. Determining Whether or not a Management Apparatus Exists (S420)

After the above step of monitoring the air pollution status and the step of creating the data, the place setting the compared critical values changes depending on whether or not the management apparatus 220 exists. When the management apparatus 220 exists, the data is compared with the critical values of the management apparatus 220. Further, when the management apparatus 220 does not exist, the data is compared with the critical values of the collected information providing apparatus 210 in the subsequent step.

2. Comparing Data with Critical Values of the Collected Information Providing Apparatus (S430)

When the management apparatus 220 does not exist in S420, users compare the contaminated air with the critical values preset in the collected information providing apparatus 210. That is, the data about air pollution status is compared with the predetermined critical values.

3. Transferring Air Collection Command (S440)

When the data about air pollution status, compared in S430, is higher than the critical values predetermined by users, the air collecting command is transferred to the air collecting unit 130.

4. Collecting Air (S450)

The air collecting unit 130, received the air collecting command from S440, collects and stores some contaminated air.

### Second Embodiment: Method

The method of collecting contaminated air according a second embodiment of the present invention will be described in detail through a flowchart shown in FIG. 5 with reference to FIGS. 1 to 3.

1. Monitoring (S510)

The air pollution status in the pertinent area is monitored in real time. The description thereof that overlaps with that of the method of the first embodiment will be omitted.

2. Creating Data (S520)

The information about the air pollution status monitored in S411 is changed into data.

3. Transmitting Data (S530)

The data information created in S520 is transmitted to the outside.

4. Storing Data (S540)

The data transmitted in S520 is in stored in the data storage unit 160 of the contaminated air collecting apparatus 100.

5. Comparing Data with Critical Values (S550)

The data created in S520 is compared with the critical values preset by users. Here, the data about air pollution status is compared with the predetermined critical values.

6. Transferring Air Collecting Command (S560)

When the air pollution status data compared in S550 is higher than the critical values preset by users, the air collection command is transferred to the air collecting unit 130.

7. Collecting Air (S570)

The air collecting unit 130 receives the air collection command transferred in S560 to collect and store a part of the contaminated air.

1. An apparatus for collecting contaminated air, comprising:
an air pollution detecting unit for monitoring pollution status of air existing in a pertinent area;
an air collecting unit for collecting and storing some of the air; and
a control unit for comparing data about the air pollution status monitored by the air pollution detecting unit with preset critical values and commanding the air collecting unit to collect some of the air when the data about the air pollution status is equal to or greater than the critical values.

2. The apparatus of claim 1, further comprising a communication unit for transmitting the data about the air pollution status monitored by the air pollution detecting unit to the outside.

3. The apparatus of claim 1, further comprising a data storage unit for storing the data about the air pollution status monitored by the air pollution detecting unit.

4. The apparatus of claim 1, further comprising an external interface unit connected to external terminals such that critical values for comparing the data about the air pollution status are set.

5. The apparatus of claim 1, wherein the air is air containing gaseous contaminants discharged from an outlet.

6. A system for collecting contaminated air, comprising:
an air pollution detecting unit for monitoring pollution status of air existing in the pertinent area;
an air collecting unit for collecting and storing some of the air;
a control unit for comparing data about the air pollution status monitored by the air pollution detecting unit with first preset critical values and commanding the air collecting unit to collect some of the air when the data about the air pollution status is equal to or greater than the first preset critical values; and
a communication unit for transmitting the data about the air pollution status monitored by the air pollution detecting unit to the outside.

7. The system of claim 6, further comprising a management apparatus for receiving the information monitored by the air pollution detecting unit and comparing data about the air pollution status with second preset critical values and commanding the air collecting unit to collect some of the air when the data about the air pollution status is equal to or greater than the second preset critical values, wherein the air collecting unit collects and stores some of the air depending on the comparison in the management apparatus.

8. The system of claim 7, wherein the management apparatus comprises:
a data storage unit for storing the data about the air pollution status;
a communication unit for transmitting and receiving the data about the air pollution status to and from the air collection unit; and
a control unit for comparing the data about the air pollution status with first preset critical values and commanding the air collecting unit to collect some of the air.

9. The system of claim 8, further comprising a management interface unit connected to external terminals such that critical values for comparing the data about the air pollution status can be set.

10. The system of claim 6, wherein the air is air containing gaseous contaminants discharged from an outlet.

11. A method of collecting contaminated air, comprising the steps of:
receiving data about air pollution status in a pertinent area from the outside;
comparing the received data about the air pollution status with preset critical values; and
commanding an air collecting unit to collect some of the air when the data about the air pollution status is equal to or greater than the preset critical values.

12. The method of claim 11, further comprising the step of storing the received data in a database.

13. A method of collecting contaminated air, comprising the steps of:
monitoring air pollution status in a pertinent area;
comparing the data about the monitored air pollution status with preset critical values; and
collecting some of the air when the data about the air pollution status is equal to or greater than the preset critical values.

14. The method of claim 13, further comprising the step of transmitting the data about the monitored air pollution status to the outside.

15. The method of claim 13, further comprising the step of storing the data about the monitored air pollution status in a database.

16. The method of claim 11, wherein the air is air containing gaseous contaminants discharged from an outlet.

17. The method of claim 12, wherein the air is air containing gaseous contaminants discharged from an outlet.

18. The method of claim 13, wherein the air is air containing gaseous contaminants discharged from an outlet.
